(19) United States
(12) Patent Application Publication
(10) Pub. No.: US 2026/0350336 A1
(43) Pub. Date: Nov. 5, 2026

(54) RADIO-FREQUENCY IDENTIFICATION (RFID) TAG AND A METHOD OF MANUFACTURING

(71) Applicant: Avery Dennison Retail Information Services LLC, Mentor, OH (US)

(72) Inventors: Peter COCKERELL, Nottinghamshire (GB); Edward J. McGINNISS, Clinton, SC (US); Christian K. OELSNER, Greensboro, NC (US); Joshua SPARROW, Greenwood, SC (US); Samantha STRANGE, Simpsonville, NC (US); Luigi SARTOR, Arcadia, CA (US)

(21) Appl. No.: 19/664,379

(22) Filed: Apr. 30, 2026

Related U.S. Application Data
(60) Provisional application No. 63/798,194, filed on May 1, 2025.
(60) Provisional application No. 63/814,536, filed on May 30, 2025.

(51) Int. Cl. G06K 19/07; G06K 19/077

(52) U.S. Cl. CPC G06K 19/0724; G06K 19/07784

(57) ABSTRACT

The present disclosure provides a radio-frequency identification (RFID) tag comprising an antenna, a strap electrically connected to the antenna, and a pattern printed layer, wherein the pattern printed layer comprises a discontinuous adhesive pattern comprising adhesive areas and non-adhesive areas to control dewetting behavior and adhesive release characteristics. The pattern printed layer may be positioned between a liner and at least one of the antenna or the strap. The discontinuous adhesive pattern may be formed in geometric shapes including hexagonal patterns, circular patterns, square patterns, triangle patterns, polygonal patterns, diagonal patterns, horizontal lines, circular patterns, zigzag patterns, vertical lines or as otherwise described herein. The pattern printed layer may control release and improve die cutting yield, and facilitates waste removal during die cutting operations.

### CROSS-REFERENCE TO RELATED APPLICATION

The present application claims priority to U.S. Provisional Application Nos. 63/798,194 filed May 1, 2025 and 63/814,536 filed May 30, 2025, the entire contents and disclosures of each of which are hereby incorporated by reference.

### FIELD OF INVENTION

The present disclosure relates to radio-frequency identification (RFID) tags and methods of manufacturing RFID tags, and more particularly to RFID tags with pattern printed layers configured to modify adhesion characteristics in specific areas.

### BACKGROUND

Radio-frequency identification (RFID) technology has become increasingly prevalent in various industries for tracking and identifying objects. RFID systems typically consist of tags containing information and readers that can wirelessly retrieve that information. These systems offer advantages over traditional barcode technology, such as the ability to read multiple tags simultaneously without line-of-sight requirements.

In many RFID applications, tags are attached to items using adhesives. The construction of an RFID tag often involves multiple layers, including an antenna, a microchip, a strap/interposer (which serves as a bonding pad for the chip), and various adhesive layers. The integrity of these adhesive bonds may be important for maintaining the tag's functionality throughout its intended lifespan.

One challenge in RFID tag manufacturing is balancing the need for strong adhesion between components with the requirements for optimal radio frequency performance. Adhesive layers that are too thick may interfere with the tag's ability to communicate effectively with readers. Conversely, insufficient adhesion may lead to component separation, potentially rendering the tag inoperable.

The process of attaching the interposer or strap (which includes the chip) to the antenna, known as strap attach, is a particularly delicate step in RFID tag production. The electrical connection between these components should be reliable, while the mechanical bond is designed to withstand various environmental stresses and handling during application and use.

In recent years, RFID tag manufacturing has faced the "sticky strap" problem. This problem arises from the conflicting requirements of the strength of the strap adhesive layer and radio frequency (RF) performance in the attachment of the interposer or strap to the antenna. The core of the issue lies in the thickness of the strap adhesive layer. To achieve optimal RF performance, the adhesive layer must be very thin, typically 4-6 μm thick. However, this thin adhesive layer may result in weak mechanical bonding between the strap and the antenna. The weak mechanical bond may lead to a common failure mode, where the strap delaminates from the antenna when a label is removed from its liner for application. This delamination can render the RFID tag inoperable, causing product failures and reliability issues in real-world applications.

Traditional solutions to address the sticky strap problem include applying a thin laminate such as Electro Static Dissipative Laminate (ESD Laminate) over the strap to keep the strap from delaminating, making inlays on a carrier and inverting the inlay to sandwich the strap between the face stock and the carrier, or in many cases, using both solutions together. However, these approaches may add complexity and cost to the manufacturing process.

Another significant issue in RFID tag manufacturing is the bond pad flipping problem. This may occur during the inlay transfer process of RFID manufacturing and is a result of adhesive strength differences. Specifically, the antenna pressure-sensitive adhesive (PSA) to the liner may be stronger than the strap PSA to the antenna. During inlay transfer, a portion of the bond pad may not be cleanly transferred, causing the strap-antenna interface to sit unevenly. When a functional liner is subsequently laminated, the bond pad may flip thereby potentially compromising tag performance.

Further, another significant technical challenge in RFID tag manufacturing involves dewetting and uncontrolled release of adhesive during the production process. Dewetting refers to the phenomenon where adhesive films spontaneously break up or retract from surfaces, creating irregular patterns of adhesive coverage. This uncontrolled dewetting may lead to inconsistent adhesive distribution across the tag components, resulting in unpredictable bond strength variations that directly contribute to both the sticky strap and bond pad flipping problems. When dewetting occurs randomly, it may create areas of insufficient adhesive coverage in critical bonding regions, while simultaneously causing excessive adhesive buildup in other areas. The uncontrolled release characteristics stemming from irregular dewetting patterns may compromise the reliability of the strap-to-antenna connection and may interfere with antenna transfer processes. Additionally, poor film formation on carriers may exacerbate dewetting issues, leading to further inconsistencies in adhesive performance. These dewetting-related problems may significantly impact manufacturing yields and product reliability, as the resulting non-uniform adhesive distribution may cause failures during RFID tag application and use.

As RFID technology continues to evolve and find new applications, there is a constant drive to enhance tag reliability, reduce production costs, and improve overall system performance. Advancements in materials science, manufacturing processes, and tag design all may contribute to the ongoing refinement of RFID technology.

Accordingly, there is a long-standing need for an improved RFID tag and method of RFID tag manufacturing that can overcome the aforementioned limitations and challenges while maintaining reliable electrical performance and robust mechanical integrity.

### SUMMARY

The summary above and the following detailed description of illustrative embodiments are better understood when read in conjunction with the appended drawings. For the purpose of illustrating the present subject matter, exemplary constructions of the subject matter are shown in the drawings. However, the present subject matter is not limited to the specific methods and instrumentalities disclosed herein. Moreover, those in the art will understand that the drawings are not to scale. Wherever possible, like elements have been indicated by identical numbers.

In some embodiments, a radio-frequency identification (RFID) tag is provided. The RFID tag may include an antenna, a strap electrically connected to the antenna, and a pattern printed layer. The pattern printed layer may be configured to modify adhesion characteristics in a specific area of the RFID tag.

In some embodiments, a method of manufacturing a radio-frequency identification (RFID) tag is provided. The method may involve electrically connecting an antenna to a strap and applying a pattern printed layer between a liner and at least one of the antenna or the strap. The pattern printed layer may be configured to modify adhesion characteristics in a specific area of the RFID tag.

In some embodiments, a method of optimizing adhesion in a radio-frequency identification (RFID) tag is provided. The RFID tag may include identifying areas proximate to a connection between antenna leads and a strap of the RFID tag requiring different adhesion characteristics, and selectively modifying adhesive properties in the identified areas by pattern printing an adhesive layer.

In some embodiments, a radio-frequency identification (RFID) tag laminate structure may comprise an antenna, a strap electrically connected to the antenna, a pattern printed layer, and a facestock layer disposed over the antenna and the strap. The pattern printed layer may be configured to modify adhesion characteristics in a specific area of the RFID tag laminate structure.

In some embodiments, a radio-frequency identification (RFID) tag comprises an antenna, a strap electrically connected to the antenna, and a pattern printed layer. The pattern printed layer comprises a discontinuous adhesive pattern comprising adhesive areas and non-adhesive areas to control dewetting behavior and adhesive release characteristics. In one embodiment the discontinuous adhesive pattern may be configured to influence adhesive flow, stress distribution, or peel initiation. In one embodiment, the adhesive areas may be separated by the non-adhesive areas. In one embodiment, the non-adhesive areas may be separated by the adhesive areas. The pattern printed layer may comprise a first pattern and a second pattern, wherein the first pattern is different from the second pattern.

In some embodiments, a method for manufacturing an RFID tag comprises applying a pattern printed layer on a liner, wherein the pattern printed layer comprises a discontinuous adhesive pattern comprising adhesive areas and non-adhesive areas to control dewetting behavior and adhesive release characteristics, forming an antenna on the liner over the pattern printed layer, and electrically connecting a strap to the antenna.

In some embodiments, a method for controlling dewetting behavior and controlled release in a radio-frequency identification (RFID) tag comprises applying a pattern printed layer on a substrate, wherein the pattern printed layer comprises a discontinuous adhesive pattern comprising adhesive regions and non-adhesive regions, controlling dewetting behavior by configuring the non-adhesive regions to create controlled adhesive flow paths, and controlling release characteristics by positioning the adhesive regions and non-adhesive regions to provide predetermined separation points.

In some embodiments, a radio-frequency identification (RFID) tag with controlled dewetting behavior and controlled release comprises a substrate and a pattern printed layer applied on the substrate, wherein the pattern printed layer comprises a discontinuous adhesive pattern comprising adhesive regions and non-adhesive regions. The non-adhesive regions are configured to create controlled adhesive flow paths to control dewetting behavior, and the adhesive regions and non-adhesive regions are positioned to provide predetermined separation points for controlling release characteristics.

The foregoing general description of the illustrative embodiments and the following detailed description thereof are merely exemplary aspects of the teachings of this disclosure and are not restrictive.

### BRIEF DESCRIPTION OF DRAWINGS

Embodiments of the present subject matter will now be described, by way of example only, with reference to the accompanying diagrams, wherein:

FIG. 1A illustrates an exploded view of a laminate structure of an RFID tag, in accordance with an embodiment.

FIGS. 1B-1D illustrate various discontinuous adhesive patterns including adhesive and non-adhesive areas, in accordance with the embodiments disclosed herein.

FIG. 2 illustrates an exploded view of a laminate structure of an RFID tag, in accordance with another embodiment.

FIG. 3 illustrates an exploded view of a laminate structure of an RFID tag having a pattern printed layer with separate layers of a first pattern and a second pattern, in accordance with another embodiment.

FIGS. 4A and 4B illustrate an exploded view of a laminate structure of an RFID tag having a pattern printed layer with integrated first and second patterns, in accordance with another embodiment.

FIGS. 5A and 5B illustrate the first pattern and second pattern of the pattern printed layer of the RFID tag, in accordance with the embodiments disclosed herein.

FIGS. 6A-6C illustrate a stepwise process for forming a pattern printed layer with integrated first and second patterns, in accordance with the embodiments disclosed herein.

FIG. 7 illustrates a method of manufacturing an RFID tag, in accordance with an embodiment.

FIG. 8 illustrates a method of improving adhesion in an RFID tag, in accordance with an embodiment.

FIG. 9 illustrates a method for manufacturing an RFID tag, in accordance with an embodiment.

FIG. 10 illustrates a method for controlling dewetting behavior and controlled release in a radio-frequency identification (RFID) tag, in accordance with an embodiment.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates various embodiments of the present subject matter and ways in which they can be implemented. Although some modes of carrying out the present subject matter have been disclosed, those skilled in the art would recognize that other embodiments for carrying out or practicing the present subject matter are also possible. Some embodiments disclosed herein include a radio-frequency identification (RFID) tag and a method of manufacturing the same.

Definitions:
“Antenna” refers to a device that is used to transmit and receive radio frequency signals in an RFID system.
"Strap" or "Interposer" refers to conductive leads that facilitate electrical connection between the integrated circuit and the antenna.
"Adhesive layer" refers to a layer of a substance that enables attachment of two layers or material surfaces.
"RFID tag" refers to a radio frequency identification tag that uses radio waves to identify and enable tracking of an object to which it is attached.

These and other features, aspects, embodiments, and advantages of the present subject matter will be better understood with reference to the following description and the appended claims. The foregoing definitions are provided to introduce selected concepts in simplified form and are not intended to identify key, essential, or limiting features of the claimed or disclosed subject matter, nor to limit the scope of the claims in any manner.

The present disclosure describes various embodiments of radio-frequency identification (RFID) tags and methods for their manufacture. RFID tags may be implemented as active devices, which include a power source, or as passive devices, which do not include a power source. In some embodiments, a radio-frequency identification (RFID) tag may include an antenna, a strap or interposer electrically connected to the antenna, and a pattern printed layer. The antenna comprises antenna leads, wherein conductive end portions of the antenna are electrically connected to the strap. The strap consists of an integrated circuit (IC) or microchip attached to conductive leads or pads. These conductive leads serve as a bridge between the IC and the conductive end portions of the antenna of the RFID tag. The pattern printed layer may be configured to modify adhesion characteristics in a specific area of the RFID tag. The pattern printed layer may be configured to reduce adhesive strength in an area proximate to a connection between the antenna leads and the strap. In some embodiments, the pattern printed layer may maintain overall adhesion of the RFID tag while reducing adhesive strength in the specific area. For example, the pattern printed layer may be configured to provide less adhesive strength than a strap adhesive strength.

In some embodiments, the pattern printed layer comprises a first pattern and a second pattern. The first pattern, having a first adhesive characteristic, may be printed in an area corresponding to the antenna, while the second pattern, having a second adhesive characteristic, may be printed in a bond-pad area where the strap connects to the antenna. In some embodiments, the second adhesive characteristic may differ from the first adhesive characteristic, and in some embodiments, in terms of adhesion strength, the second adhesive characteristic may be less than the first adhesive characteristic. Adhesion characteristics may include release force, peel strength, tack and effective bonding area. In some embodiments, the adhesion characteristics may be increased, decreased, or otherwise tailored.

In one exemplary embodiment, the pattern printed layer may reduce adhesive strength in an area proximate to a bond pad area where the strap connects to the antenna leads. This reduced adhesive strength may prevent delamination of the strap from the antenna when the RFID tag is removed from a liner for application to an object or when the inlay is transferred from one substrate to another during a manufacturing process (e.g., from a carrier to the facestock). The reduced adhesive strength in the area proximate to the bond pad where the strap connects to the antenna leads may avoid flipping of the bond pad during inlay transfer.

The RFID tag may further include a liner, with the pattern printed layer positioned between the liner and at least one of the antenna or the strap.

The pattern printed layer may comprise a plurality of discrete adhesive areas. In some implementations, a portion of the pattern printed layer may be formed in various patterns such as hexagonal patterns, circular patterns, square patterns, triangle patterns, polygonal patterns, diagonal patterns, horizontal lines, circular patterns, zigzag patterns, and vertical lines. It will be appreciated that patterns providing the desired adhesive characteristics are consistent with the embodiments disclosed herein.

In some embodiments, the pattern printed layer may be flood coated under the antenna and/or strap. For example, the first pattern may be flood coated under the area corresponding to the antenna. In some embodiments, the pattern printed layer may be printed under the antenna and/or strap. In particular, the second pattern may be printed in the specific area of the RFID tag corresponding to an area proximate to a connection between the antenna leads and the strap.

In some embodiments, the pattern printed layer may comprise a discontinuous adhesive pattern that includes adhesive areas and non-adhesive areas. In some embodiments, the pattern printed layer may comprise a discontinuous adhesive pattern that includes adhesive areas separated by non-adhesive areas or discontinuous adhesive pattern that includes non-adhesive areas separated by adhesive areas. These configurations may control dewetting behavior and adhesive release characteristics during manufacturing and use of the RFID tag. The discontinuous adhesive pattern may control dewetting behavior by creating controlled adhesive flow paths through the non-adhesive areas. In some embodiments, the discontinuous adhesive pattern may interrupt continuous wetting fronts or redistributing stresses within the adhesive layer.

The discontinuous adhesive pattern may be formed in various geometric shapes including hexagonal or honeycomb, triangular, polygonal, and circular shapes, and/or various configurations of horizontal, diagonal, or vertical lines. These geometric configurations may provide specific flow characteristics and release properties. The discontinuous adhesive pattern of discrete adhesive areas and non-adhesive areas may be combined to form additional types of patterns. It will be appreciated that these discontinuous adhesive patterns provide the desired adhesive characteristics consistent with the embodiments disclosed herein.

In some embodiments, the discontinuous adhesive pattern may allow air to get trapped in the non-adhesive areas to control release characteristics and improve die cutting yield.

In some embodiments, the discontinuous adhesive pattern may also facilitate waste removal during die cutting operations.

In some embodiments, the non-adhesive areas may prevent adhesive transfer to a substrate, thereby providing minimal adhesive residue upon separation of the RFID tag from the liner. This characteristic may improve the cleanliness of the manufacturing process and the final product.

In some embodiments, the pattern printed layer may include a first pattern in an antenna area and a surrounding area of the antenna, and a second pattern in a bond pad area where the strap connects to the antenna. The first pattern and the second pattern may have different characteristic dimensions to provide varying adhesive properties in different regions of the RFID tag.

In some embodiments, the first pattern may comprise geometric shapes having a first cell size and the second pattern may comprise geometric shapes having a second cell size different from the first cell size. The first cell size may be smaller than the second cell size. The variation in cell sizes may allow for different adhesive strengths in different areas of the RFID tag.

In some embodiments, the first pattern may be configured to control the release of adhesive from the liner to facilitate the transfer of the antenna from the liner to a facestock layer upon application of force.

In some embodiments, the second pattern may be configured to prevent delamination of the strap from the antenna when the RFID tag is removed from the liner. This may help maintain the electrical connection between the strap and antenna during handling and use.

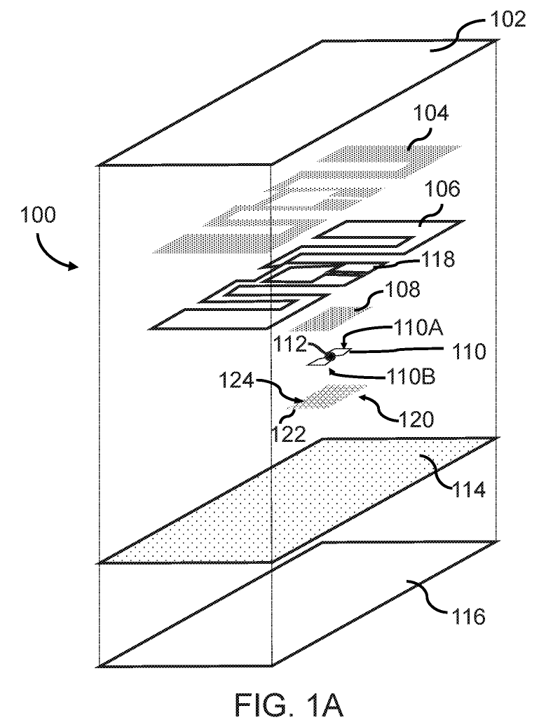

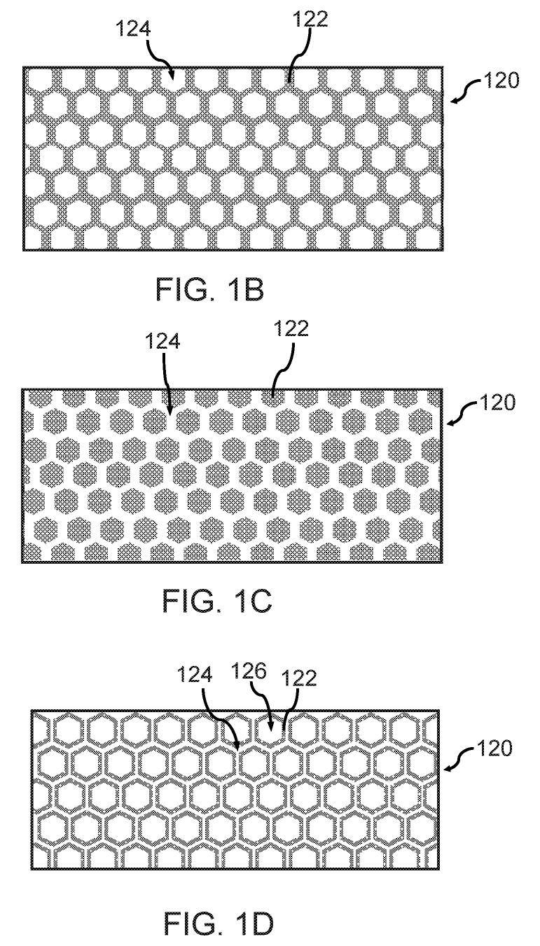

FIG. 1A is an exploded view of a laminate structure of an RFID tag 100 having a pattern printed layer positioned between the liner and the strap, in accordance with a first embodiment. The RFID tag 100 comprises a facestock layer 102, an antenna adhesive 104, an antenna 106, a strap adhesive 108, a strap 110, an RFID integrated circuit 112, a functional adhesive 114 and a liner 116. The antenna adhesive 104 may be deposited or printed in the shape of the antenna 106 or a pattern that is substantially similar to the antenna 106. The antenna 106 can be any of a variety of materials, for example, aluminum, copper, silver, conductive ink or another thin, conductive material. In some embodiments, the antenna 106 may be made from a polymer metalized with these metals, such as an aluminum/polyethylene terephthalate film. The antenna 106 may be shaped as a single dipole, dual dipoles (one perpendicular to other), a folded dipole, slot, or spiral coil. The antenna 106 comprises antenna leads 118. The antenna leads 118 are conductive end portions of the antenna 106 that electrically connect to the strap 110. The antenna 106 may be coupled to an RFID integrated circuit 112 that may be mounted to or deposited on the strap 110. The strap 110 may further include conductive leads to facilitate coupling between antenna 106 and the integrated circuit 112. In some embodiments, coupling between antenna 106 and the strap 110 may be an indirect coupling, such as a capacitive coupling.

The facestock layer 102 may be formed of a paper material, such as a cardstock paper, a bond paper or other paper type, or from flexible fabric materials including textiles, woven, nonwoven, or knitted materials. The face layer may be a monolayer or multilayer. The facestock layer 102 may have a thickness from 0.5 µm to 50 µm, e.g., from 0.5 µm to 25 µm, from 0.5 µm to 10 µm, from 0.7 µm to 5 µm, or more preferably from 1 µm to 4.5 µm. In other embodiments, the facestock may be thicker without departing from the scope of the present disclosure. The facestock layer 102 may also include a printable surface for displaying information associated with the RFID label or tag, such as product identification, branding, or tracking data.

The strap 110 further comprises a front side 110A, also referred to as an active side, and a back side 110B. The RFID integrated circuit 112 may be mounted on the front side 110A. The pattern printed layer 120 may be applied on the back side 110B of the strap 110. The pattern printed layer 120 may comprise an adhesive, a release agent, a varnish, or a combination thereof. As shown in FIGS. 1A-1C, the pattern printed layer 120 is a pattern printed adhesive layer. The pattern printed layer 120 may be positioned between the liner 116 and the strap 110 with the functional adhesive layer 114 interposed between the pattern printed layer 120 and the liner 116.

The RFID integrated circuit 112 may be operatively coupled to the antenna 106 using the strap 110. The RFID integrated circuit may comprise a logic unit that makes decisions and/or memory to store data, such as tag ID, object identifier, passwords, etc. The RFID integrated circuit may be configured for use in an active RFID device or a passive RFID device. The RFID integrated circuit may be fabricated from semiconductor wafers, and any suitably sized RFID integrated circuit may be used with the embodiments disclosed herein. In some embodiments, the RFID integrated circuit may be encoded with information relating to a product with which the RFID device is to be associated. Encoding may be performed before placement of the RFID integrated circuit on the antenna structure or after placement.

The pattern printed layer 120 comprises adhesive areas 122 and non-adhesive areas 124. In some embodiments, the pattern printed layer 120 may have a discontinuous adhesive pattern comprising adhesive areas and non-adhesive areas to control dewetting behavior and adhesive release characteristics.

The pattern printed layer may comprise a plurality of discrete non-adhesive areas. These discrete non-adhesive areas create spaces between the adhesive areas and the spaces that have no adhesive, creating a non-uniform adhesive distribution. In some embodiments, the non-uniform adhesive distribution may be advantageous for modifying adhesion characteristics in a specific area of the RFID tag 100. In one embodiment, the pattern printed layer 120 may have a discontinuous adhesive pattern in which the non-adhesive areas 124 are separated by the adhesive areas 122 as shown in FIG. 1B. In such a configuration, the adhesive areas 122 may be interconnected. As shown in FIG. 1B, the non-adhesive areas 124 may have a regular shape in the form of a hexagonal or honeycomb, triangular, polygonal, and circular shapes, and/or various configurations of horizontal, diagonal, or vertical lines. Preferably, the shape may be a hexagon arranged to form a honeycomb configuration. The pattern printed layer 120 may be constructed in a variety of patterns for the non-adhesive areas 124.

The pattern printed layer may comprise a plurality of discrete adhesive areas. The spaces between the plurality of discrete adhesive areas that have no adhesive, creating a non-uniform adhesive distribution. In some embodiments, the non-uniform adhesive distribution may be advantageous for modifying adhesion characteristics in a specific area of the RFID tag 100. In one embodiment, the pattern printed layer 120 may have a discontinuous adhesive pattern in which the adhesive areas 122 are separated by the non-adhesive areas 124 as shown in FIG. 1C. In such a configuration, the non-adhesive areas 124 may be interconnected. As shown in FIG. 1C, the adhesive areas 122 may have a regular shape in the form of a hexagonal or honeycomb, triangular, polygonal, and circular shapes, and/or various configurations of horizontal, diagonal, or vertical lines. Preferably, the shape may be a hexagon arranged to form a honeycomb configuration. The pattern printed layer 120 may be constructed in a variety of patterns for the adhesive areas 122.

FIG. 1D illustrates another embodiment in which the pattern printed layer 120 may have adhesive areas 122 that are separated by the non-adhesive areas 124 and also have an internal non-adhesive area 126. The internal non-adhesive area 126 may be separated from the non-adhesive areas 124. In other embodiments, there may be splits or gaps in the adhesive areas 122 to connect the non-adhesive areas 124 and the internal non-adhesive area 126. The adhesive areas 122 and internal non-adhesive area 126 may have a similar shape in the form of a hexagonal or honeycomb, triangular, polygonal, and circular shapes, and/or various configurations of horizontal, diagonal, or vertical lines.

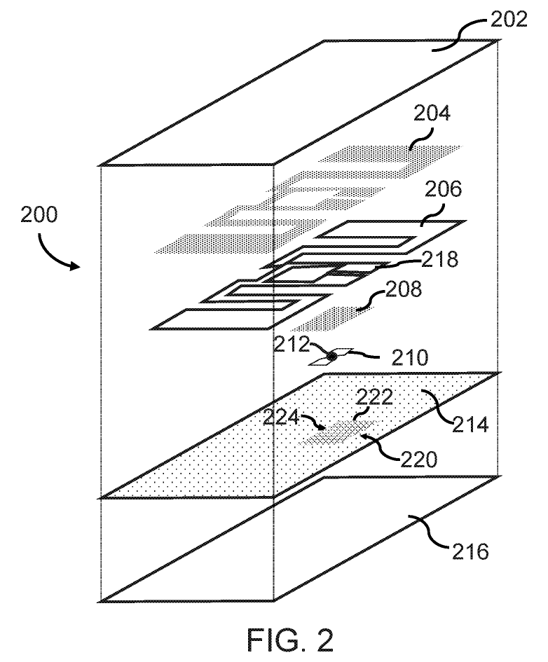

It should be understood that the arrangement of the layers shown in FIG. 1A and the other figures is merely illustrative and the layers may be rearranged or may be combined in some embodiments. As shown in FIG. 1A, the pattern printed layer is a separate layer from the other adhesive layers. In one embodiment, the pattern printed layer may be integrated or formed as part of another adhesive layer. FIG. 2 illustrates an embodiment in which the pattern printed layer 220 is integrated with another adhesive layer. FIG. 2 is an exploded view of a laminate structure of an RFID tag 200, in accordance with a second embodiment. The RFID tag 200 comprises a functional facestock layer 202, an antenna adhesive 204, an antenna 206, a strap adhesive 208, a strap 210, a functional adhesive 214, and a liner 216. The strap 210 may comprise an RFID integrated circuit 212. The functional adhesive 214 comprises a pattern printed layer 220. In some embodiments, pattern printed layer 220 may be integrated or otherwise formed with the functional adhesive 214. In some embodiments, the pattern printed layer 220 formed on or with the functional adhesive 214 may comprise an adhesive, a release agent, a varnish, or a combination thereof. The pattern printed layer 220 may be disposed between the strap 210 and the liner 216. The pattern printed layer 220 may comprise discrete adhesive areas 222 and non-adhesive areas 224 as described herein. A portion of the pattern printed layer 220 may have reduced adhesive strength in the area proximate to the connection between the antenna leads 218 and/or the strap 210. The pattern printed layer 220 may maintain overall adhesion while reducing adhesive strength in the area proximate to the connection between the antenna leads 218 and/or the strap 210.

In some embodiments, the adhesive characteristics of the pattern printed layer 220 may be different from the functional adhesive 214. The pattern printed layer 220 may be configured to provide less adhesive strength than the adhesive strength of strap adhesive 208. The reduced adhesive strength in the area proximate to the connection between the antenna leads and the strap 210 prevents delamination of the strap 210 from the antenna 206 when the RFID tag 200 is removed from the liner 216.

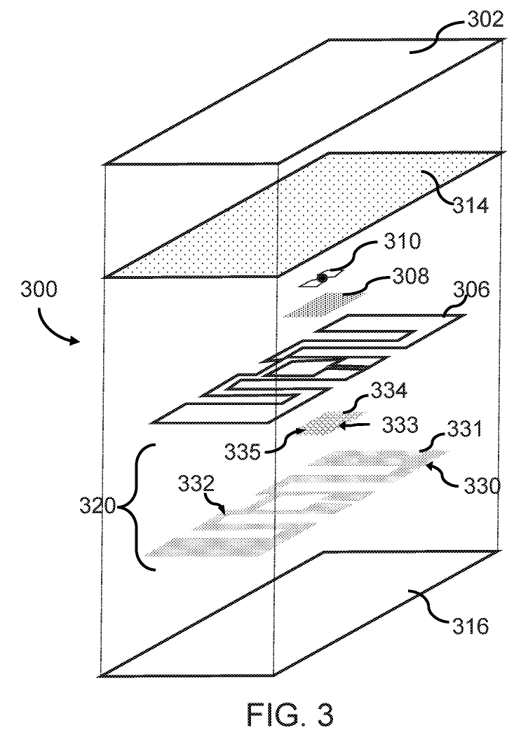

FIG. 3 is an exploded view of a laminate structure of an RFID tag 300 where the pattern printed layer comprises a first pattern in an antenna area and a surrounding area of the antenna and a second pattern in a bond pad area where the strap connects to the antenna, in accordance with a third embodiment. In some embodiments, the first pattern and the second pattern have different characteristic dimensions. The characteristic dimensions may include various geometric parameters such as cell size, pattern density, wall thickness, and spacing between pattern elements. The first characteristic dimensions may be selected to control dewetting and release characteristics suitable for antenna handling, while the second characteristic dimensions may be selected to prevent strap delamination and bond pad flipping.

In FIG. 3, the RFID tag 300 may be arranged as follows a functional facestock layer 302 is positioned above the functional adhesive 314 and the strap 310 may be positioned on one side of the functional adhesive 314 opposite to the functional facestock layer 302. The strap 310 may be mounted to the antenna 306 by the strap adhesive 308. A pattern printed layer 320 may be positioned between the antenna 306 and a liner 316. In FIG. 3, the pattern printed layer 320 comprises a first pattern 330 and a second pattern 332. The first pattern 330 may be configured to have a shape that corresponds to an antenna area or corresponds to an surrounding area of the antenna 306. The second pattern 332 may have an area that corresponds to the bond pad area where the strap 310 connects to the antenna 306 or may be substantially similar to this bond pad area. The first pattern 330 and the second pattern 332 may be formed as separated layers. The first pattern 330 may comprise adhesive areas 331 and non-adhesive areas 332 in the patterns as described herein. The second pattern 333 may comprise adhesive areas 334 and non-adhesive areas 335 in the patterns as described herein. The non-adhesive areas 332 and 335 create spaces between the plurality of discrete adhesive areas 331 and 334 that have no adhesive. The first pattern 330 may comprise geometric shapes having a size and/or configuration that is different from the geometric shapes used for the second pattern 333. Accordingly, the first pattern 330 is configured to provide a first adhesive strength and the second pattern 333 is configured to provide a second adhesive strength. Preferably, the second adhesive strength is less than the first adhesive strength. In some embodiments, the second pattern 333 may be configured to prevent delamination of the strap 310 from the antenna 306 when the RFID tag 300 is removed from a liner 316.

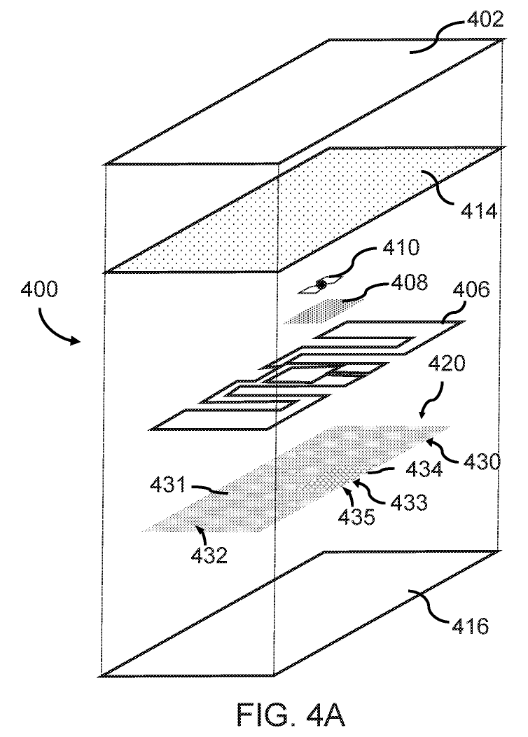

In some embodiments, the first pattern and the second pattern may be formed as integrated layers as shown in FIGS. 4A and 4B. The RFID tag 400 is a laminate structure comprising a facestock layer 402, an antenna 406, a strap adhesive 408, a strap 410, a functional adhesive 414, a liner 416, and a pattern printed layer 420. It should be understood that the RFID integrated circuit may be connected to the strap 410 as described herein. The RFID tag 400 may be arranged as follows a functional facestock layer 402 is positioned above the functional adhesive 414 and the strap 410 may be positioned on one side of the functional adhesive 414 opposite to the functional facestock layer 402. The strap 410 may be mounted to the antenna 406 by the strap adhesive 408. A pattern printed layer 420 may be positioned between the antenna 406 and a liner 416. The pattern printed layer 420 comprises a first pattern 430 and a second pattern 433 that are formed together as one layer. In FIG. 4A, the pattern printed layer 420 comprises a first pattern 430 may have an area that is larger than the area of the antenna 406. In FIG. 4B, the pattern printed layer 420 comprises a first pattern 430 may have an area that is substantially similar to the area of the antenna 406. The first pattern 430 may comprise discrete adhesive areas 431 and non-adhesive areas 432 in the patterns as described herein. Likewise, the second pattern 433 may comprise discrete adhesive areas 434 and non-adhesive areas 435 in the patterns as described herein. In some embodiments, the first pattern 430 may comprise geometric shapes having a size and/or configuration that is different from the geometric shapes used for the second pattern 433. Accordingly, the first pattern 430 is configured to provide a first adhesive strength and the second pattern 433 is configured to provide a second adhesive strength. Preferably, the second adhesive strength is less than the first adhesive strength. In some embodiments, the second pattern 433 may be configured to prevent delamination of the strap 410 from the antenna 406 when the RFID tag 400 is removed from a liner 416.

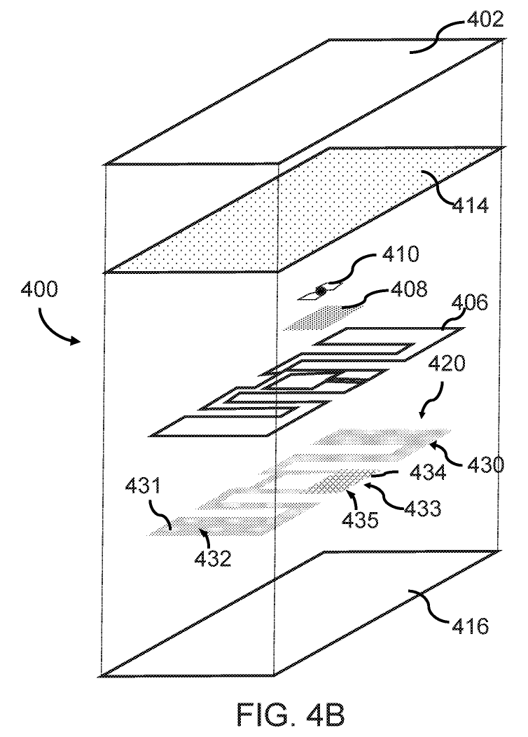

FIGS. 5A and 5B illustrate various pattern printed layer 520 according to the embodiments described herein. In FIG. 5A the pattern printed layer 520 comprises a first pattern 530 and a second pattern 533. The first pattern 530 is larger than the antenna area 536. In FIG. 5B, the first pattern 530 has a dimension that is similar to the antenna area 536. As can be seen, the first pattern 530 shown in FIG. 5B is largely contained within the outline of the antenna, rather than extending into a surrounding area of the antenna as in FIG. 5A. The second pattern 533, which may be smaller in size than the first pattern 530 may be positioned in the bond area 538 that corresponds to the bonding pads and/or strap. The first pattern 530 comprises adhesive areas 531 and non-adhesive areas 532. The second pattern 533 comprises adhesive areas 534 and non-adhesive areas 535. As shown in FIGS. 5A and 5B, the first pattern 530 is a roughly rectangular patch made of honeycomb shapes having a first cell size. The first cell size of each honeycomb shape of the first pattern 530 is different from a second cell size of each honeycomb shape of the second pattern 533. The first cell size may be smaller than the second cell size. One skilled in the art will appreciate that other configurations of the first pattern 530 and/or second pattern 533 are possible while remaining consistent with the embodiments disclosed herein.

In some embodiments, the first pattern 530 may be different from the second pattern 533. In one exemplary embodiment, the first pattern 530 may have the construction shown in FIG. 1B and the second pattern 533 may have the construction shown in FIG. 1C. One skilled in the art will appreciate that other configurations of the first pattern 530 and/or the second pattern 533 are possible while remaining consistent with the embodiment disclosed herein. Other combinations of patterns are contemplated by the present disclosure.

Again referring back to FIGS. 5A and 5B, the first pattern 530 comprises a first cell size and the second pattern 533 comprise a second cell size. In some embodiments, as shown in FIGS. 5A and 5B, the first cell size may be smaller than the second cell size, and may be at least 90% of, or smaller than, the second cell size, e.g., at least 75% or smaller. The cell size may refer to the shape of the discontinuous adhesive area or the discontinuous non-adhesive area. The first pattern 530 is configured to provide a first adhesive strength and the second pattern is configured to provide a second adhesive strength. In some embodiments, the second adhesive strength may be less than the first adhesive strength. The first pattern 530 may be configured to control the release of the adhesive from the liner 516 to facilitate the transfer of the antenna 506 from the liner 516 to the functional facestock 502 upon application of force. The second pattern 533 may be configured to prevent delamination of the strap 510 from the antenna 506 when the RFID tag 500 is removed from the liner 516.

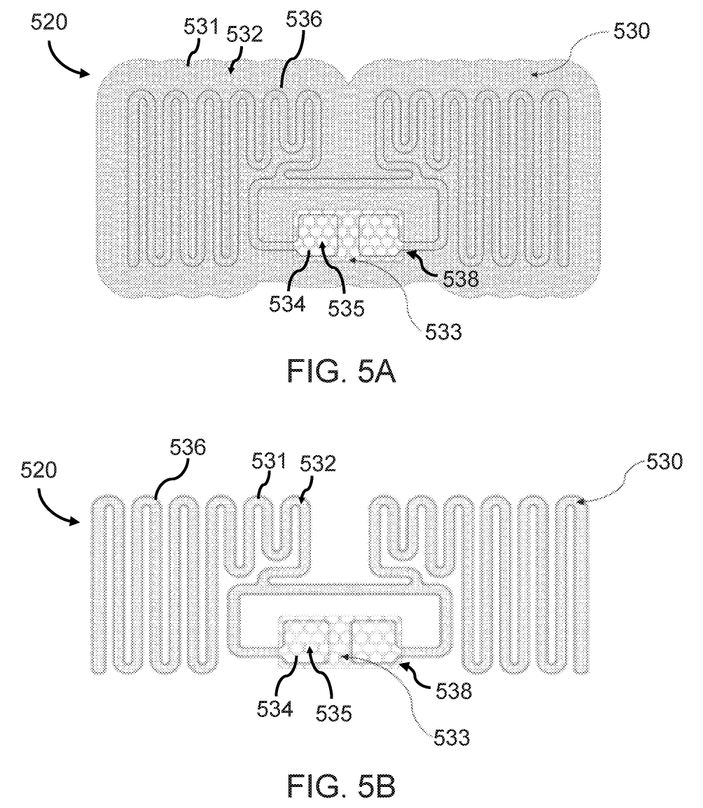

FIGS. 6A-6C illustrate a stepwise schematic flow of manufacturing of the antenna 406 on the pattern printed layer 420. It should be understood that the stepwise schematic flow of manufacturing may be applied to the other embodiments disclosed herein. In FIG. 6A, at a first step, the first pattern 430 may be printed or applied on a base substrate 440. In some embodiments, the first pattern may be printed or applied in a shape or pattern of the antenna. The base substrate 440 is selected from a group comprising, but not limited to, a polyethylene terephthalate (PET), paper substrates, polyester films, polypropylene (PP) films, polyethylene (PE), and textile or fabric material. Next in a second step shown in FIG. 6B, a second pattern 433 may be printed or applied to the first pattern 430 to form the pattern printed layer 420. In some embodiments, the first and second steps may be done separately, or may be done together. In some embodiments, the first pattern 430 and/or second pattern 433 may be applied in a single manufacturing step that incorporates both the first and second patterns. For instance, a printing process such as flexography may be utilized to deposit an adhesive pattern encompassing both the first pattern, which corresponds to the antenna shape, and the second pattern in the bond area where the strap connects to the antenna.

As shown in FIG. 6B, the pattern printed layer 420 comprises two different patterns. A first pattern 430 with a first adhesive strength is applied on an area corresponding to the antenna. A second pattern 433 with a second adhesive strength is applied in a bond area where the strap may be connected to the antenna. In some embodiments, the area of the second pattern 433 may be less than the area of the first pattern 430. After both patterns are applied, an antenna 406 may be disposed on top of the pattern printed layer 420 as shown in FIG. 6C. A conductive material may be applied over the pattern printed layer 420. The conductive material may include, but is not limited to, metallic foils, conductive inks, or other electrically conductive substances. The metallic foil may be laminated over the pattern printed layer 420, and the antenna pattern may be cut using at least one of, but not limited to, a die cutting, a laser cutting, a hybrid cutting method, or any other suitable method. In some embodiments, the pattern printed layer 420 may facilitate waste removal during die cutting. In some embodiments, the base substrate 440 may be cut along dashed lines 442 and used as the liner 416. In other embodiments, a separate liner may be added to the construction.

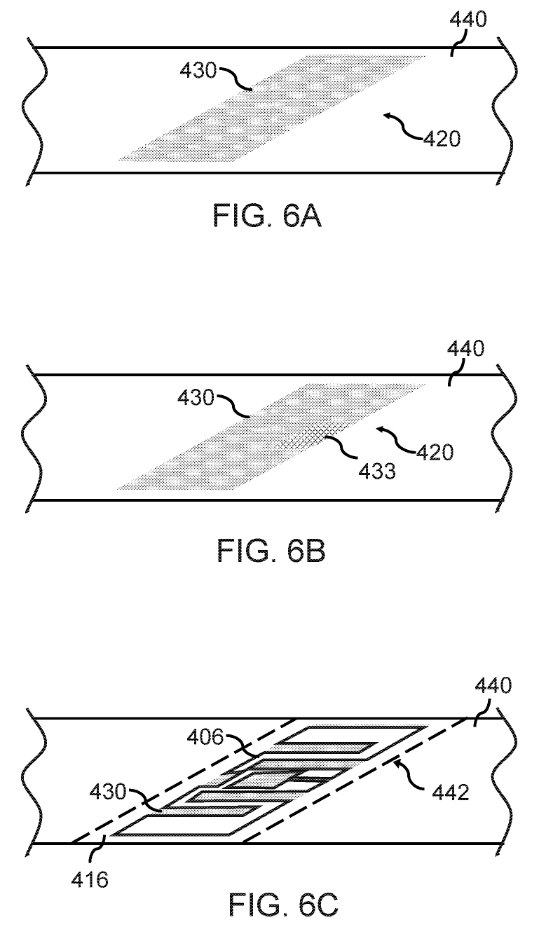

FIG. 7 is a method 700 of manufacturing an RFID tag in accordance with an embodiment. At step 702, the antenna may be electrically connected to the strap. This electrical connection may be achieved through various methods known in the art or disclosed herein. For example, the electrical connection may be formed by direct physical contact between conductive elements of the antenna and the strap, or through capacitive coupling. In some embodiments, the electrical connection may be established using conductive adhesives, soldering, welding, or mechanical pressure.

At step 704, the pattern printed layer may be applied between the liner and at least one of the antenna and/or the strap. In some embodiments the pattern printed layer may comprise the first pattern and the second pattern as described herein. By applying the pattern printed layer in such a manner with at least one of the antenna or the strap, the pattern printed layer may be configured to modify adhesion characteristics in a specific area of the RFID tag.

In some embodiments, step 704 includes applying a pattern printed layer, which may comprise applying a first pattern with a first adhesive characteristic in an area corresponding to the antenna, and applying a second pattern with a second adhesive characteristic in the bond pad area where the strap connects to the antenna, with the second adhesive characteristic being different than the first adhesive characteristic.

In some embodiments, step 704 includes applying a pattern printed layer, which may involve a step for flood coating an adhesive layer and then selectively pattern printing the adhesive layer in an area proximate to a connection between the antenna and the strap to reduce adhesive strength in the area.

The method may include steps for arranging the antenna, strap, and liner in different configurations. In one embodiment, the strap may be positioned between the antenna and the liner with the pattern printed layer between the strap and the liner.

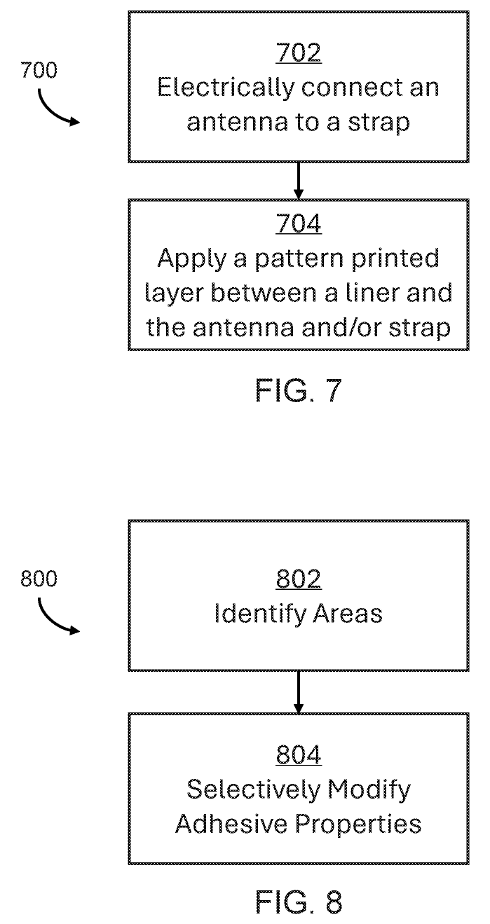

FIG. 8 is a method 800 of improving adhesion in an RFID tag in accordance with an embodiment.

At step 802, areas proximate to a connection between the antenna leads and/or a strap of the RFID tag requiring different adhesion characteristics are identified. This may include identifying an antenna area and a bond pad area where the strap connects to the antenna.

At step 804, adhesive properties in the identified areas may be selectively modified by printing or disposing a pattern printed layer. In some aspects, the method may comprise selectively modifying adhesive properties may involve applying the first pattern with the first adhesive characteristic in the identified antenna area and applying the second pattern with the second adhesive characteristic in the identified bond pad area, where the second adhesive characteristic is different from the first adhesive characteristic.

In some embodiments, the method may include flood coating an adhesive layer and pattern printing an adhesive, a release agent, or a varnish in the area proximate to the connection between the antenna leads and the strap to reduce adhesive strength at the interface of the strap and antenna.

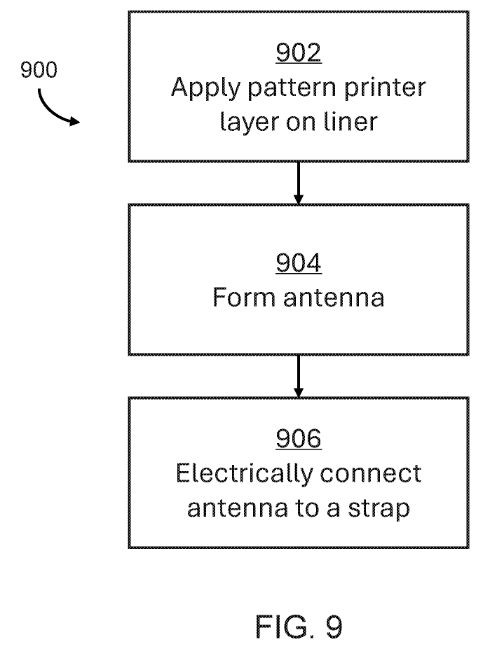

FIG. 9 illustrates a method of manufacturing an RFID tag, in accordance with an embodiment. The method begins with step 902, which involves applying a pattern printed layer on a liner. The pattern printed layer comprises a discontinuous adhesive pattern comprising adhesive areas and non-adhesive areas to control dewetting behavior and adhesive release characteristics. The application of the pattern printed layer may involve applying different patterns in different areas of the RFID tag. In some embodiments, the first pattern may be applied in an antenna area and a surrounding area of the antenna, while the second pattern may be applied in a bond pad area where the strap connects to the antenna. These patterns may have different characteristic dimensions to achieve desired adhesive properties in their respective areas.

The first pattern may comprise geometric shapes having a first cell size and the second pattern may comprise geometric shapes having a second cell size different from the first cell size. In some embodiments, the first pattern may comprise hexagonal or honeycomb, triangular, polygonal, and circular shapes, and/or various configurations of horizontal, diagonal, or vertical lines.

In some embodiments, the first pattern may comprise geometric shapes having the first cell size smaller than the second cell size of the second pattern. This variation in cell sizes may allow for different adhesive performance characteristics in different regions of the RFID tag. In some embodiments, the first pattern may result in improved release characteristics or higher adhesion performance. In some embodiments, the second pattern may control release during the transfer process to reduce and/or eliminate bond pad flipping.

At step 904, an antenna is formed on the liner over the pattern printed layer. A conductive substrate is applied on the discontinuous adhesive pattern to form the antenna. The discontinuous adhesive pattern allows air to get trapped in the non-adhesive areas to control release characteristics and improve die cutting yield. In some embodiments, die cutting yields of the antenna may be greater than 99.9% and in some embodiments, exceeding 99.98%.

Further, waste material removal during die cutting may be facilitated by the discontinuous adhesive pattern. The discontinuous adhesive pattern may create pathways that may allow for easier removal of excess material, improving manufacturing speed and improving process efficiency.

At step 906, a strap is electrically connected to the antenna. This electrical connection may be achieved through various methods known in the art or disclosed herein. For example, the electrical connection may be formed by direct physical contact between conductive elements of the antenna and the strap, or through capacitive coupling. In some embodiments, the electrical connection may be established using conductive adhesives, soldering, welding, or mechanical pressure.

The method may include transferring the antenna from the liner to a substrate, where the first pattern may control release of adhesive from the liner upon application of force. This controlled release may ensure proper transfer while maintaining the integrity of components of the RFID tag. The non-adhesive areas of the pattern printed layer may prevent adhesive transfer to the facestock layer, thereby providing minimal adhesive residue upon separation of the RFID tag from the liner. This characteristic may improve the cleanliness of the manufacturing process.

In some embodiments, the second pattern may prevent delamination of the strap from the antenna when the RFID tag is removed from the liner. This may help maintain the electrical connection between the strap and antenna during handling and subsequent processing steps, reducing manufacturing defects and improving reliability of the RFID tag.

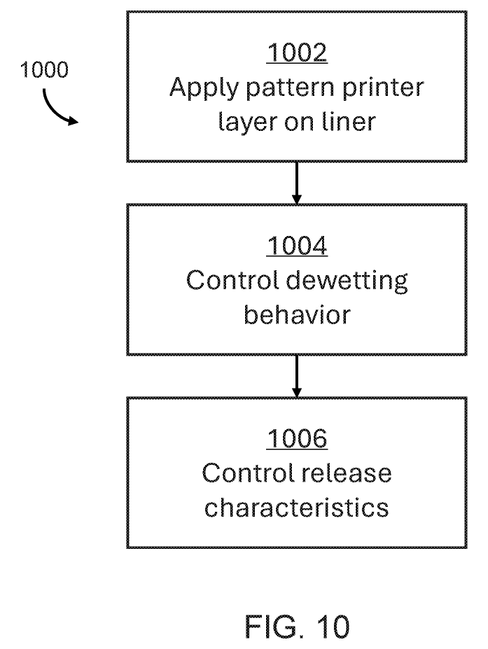

FIG. 10 illustrates a method for controlling dewetting behavior and controlled release in a radio-frequency identification (RFID) tag.

At step 1001, the pattern printed layer is applied on the substrate, wherein the pattern printed layer comprises a discontinuous adhesive pattern comprising adhesive regions and non-adhesive regions. The pattern printed layer application may include applying the first pattern in the antenna area and a surrounding area of the antenna having first characteristic dimensions, and applying the second pattern in the bond pad area having second characteristic dimensions different from the first characteristic dimensions. The characteristic dimensions may include various geometric parameters such as cell size, pattern density, wall thickness, and spacing between pattern elements. Cell size refers to the size of the adhesive or non-adhesive area. Wall thickness refers to the thickness of the adhesive areas between the non-adhesive areas. The first characteristic dimensions may be selected to control dewetting and release characteristics suitable for antenna handling, while the second characteristic dimensions may be selected to prevent strap delamination and bond pad flipping.

This step establishes the foundation for subsequent dewetting control and release characteristic management by the distribution of the discontinuous adhesive pattern across the substrate surface.

At step 1004, dewetting behavior is controlled by configuring the non-adhesive regions to create controlled adhesive flow paths. The non-adhesive regions are strategically positioned and sized to direct adhesive flow in predetermined directions, preventing random dewetting that may otherwise cause manufacturing inconsistencies. The controlled dewetting behavior comprises preventing adhesive spreading by directing adhesive flow through the controlled adhesive flow paths. The controlled adhesive flow paths confine dewetting to specific geometric areas, such as hexagonal shapes or other shapes described herein, thereby allowing controlled dewetting.

At step 1006, release characteristics are controlled by positioning the adhesive regions and non-adhesive regions to provide predetermined separation points. The predetermined separation points enable release at predetermined force levels, allowing for controlled separation during manufacturing and use processes. The predetermined separation points are strategically located to facilitate proper component transfer while maintaining structural integrity.

In some aspects, an RFID tag laminate structure is disclosed in accordance with an embodiment. The RFID tag laminate may comprise an antenna, a strap electrically connected to the antenna, a pattern printed layer, and a facestock layer disposed over the antenna and the strap. The pattern printed layer may be disposed between a liner and the antenna, or between the liner and the strap. In some embodiments, the strap may be positioned between the antenna and the liner, with the pattern printed layer between the strap and the liner. In some embodiments, the antenna may be positioned between the strap and the liner, with the pattern printed layer between the antenna and the liner. The pattern printed layer may be configured to prevent delamination of the strap from the antenna while allowing removal of the facestock layer, antenna, and strap as a unit from the liner.

In some aspects, the RFID tag and manufacturing method described herein may offer several advantages. The pattern printed layer may allow for precise control of adhesion characteristics in specific areas of the RFID tag. This targeted approach to adhesive application may help optimize the overall performance and reliability of the tag. By reducing adhesive strength in areas proximate to the connection between antenna leads and the strap, the risk of delamination during tag removal and application may be decreased. This may result in improved durability and longevity of the RFID tags in various applications.

The ability to maintain overall adhesion while selectively modifying adhesive properties in specific areas may provide a balance between secure attachment and ease of handling. This may enhance the tag's usability across different environments and conditions.

The pattern printed layer may allow for customization of adhesive patterns and strengths to suit different antenna designs, strap configurations, and application requirements. This flexibility may enable the production of RFID tags tailored to specific use cases.

The manufacturing methods described, such as pattern printing or flood coating with selective pattern printing, may offer efficient and cost-effective ways to produce RFID tags with optimized adhesive properties. This may potentially lead to reduced production costs and improved manufacturing yields.

The ability to prevent delamination of the strap from the antenna while allowing removal of the facestock layer, antenna, and strap as a unit from the liner may simplify the application process and improve the overall user experience.

By addressing common issues like the "sticky strap" problem and "bond pad flipping," the described RFID tag design may offer improved reliability and performance compared to conventional designs.

The method may allow for the use of thinner adhesive layers in specific areas of the RFID tag, potentially improving the RF performance of the tag without compromising its structural integrity. In one embodiment, the pattern printed layer, including both the first pattern and the second pattern, may have a thickness of less than or equal to 10 microns, e.g., less than or equal to 5 microns, less than or equal to 4 microns, less than or equal to 3 microns, or less than or equal to 2.5 microns.

In all these embodiments, the pattern printed layer may be configured to modify adhesion characteristics in specific areas of the RFID tag, particularly in areas proximate to the connection between the antenna leads and the strap and the areas proximate to the antenna. This modification of adhesion characteristics may help prevent issues such as delamination of the strap from the antenna or antenna from the facestock while maintaining overall adhesion of the RFID tag.

In some embodiments, the pattern printed layer may be configured to reduce, but not eliminate, the adhesive strength in the area proximate to the bond pad where the strap connects to the antenna leads. In some embodiments, the pattern printed layer may be configured to reduce, but not eliminate, the adhesive strength in the area proximate to the antenna. These approaches of decreasing adhesive strength, rather than completely eliminating adhesive in this area, may help to prevent the formation of bubbles during the manufacturing process. The presence of a reduced amount of adhesive in the bond pad area may maintain a level of adhesion that is sufficient to ensure proper contact between layers and minimize air entrapment.

In some embodiments, the adhesive strength under the bond pad may be maintained above a minimum threshold required to avoid bubbles or other manufacturing issues. This minimum threshold may vary depending on factors such as the specific materials used, the manufacturing process employed, and the environmental conditions during production.

Although the pattern printed layer may comprise a plurality of discrete adhesive and non-adhesive areas, in some embodiments, the pattern printed layer may comprise a diagonal pattern, dot pattern, horizontal lines, a circular pattern, a zigzag pattern, vertical lines, or similar patterns.

In some aspects, an RFID tag with controlled dewetting behavior and release characteristics is disclosed. The RFID tag may comprise the substrate and the pattern printed layer applied on the substrate. The pattern printed layer may include the discontinuous adhesive pattern comprising adhesive regions separated by non-adhesive regions, where the non-adhesive regions are configured to create controlled adhesive flow paths to control dewetting behavior, and the adhesive regions and non-adhesive regions are positioned to provide predetermined separation points for controlling release characteristics.

In some aspects, an RFID tag with controlled dewetting behavior and release characteristics is disclosed. The RFID tag may comprise the substrate and the pattern printed layer applied on the substrate. The pattern printed layer may include the discontinuous adhesive pattern comprising non-adhesive regions separated by adhesive regions, where the non-adhesive regions are configured to create controlled adhesive flow paths to control dewetting behavior, and the adhesive regions and non-adhesive regions are positioned to provide predetermined separation points for controlling release characteristics.

In some embodiments, the pattern printed layer comprises a first pattern in the antenna area and surrounding area of the antenna having first characteristic dimensions, and a second pattern in the bond pad area having second characteristic dimensions different from the first characteristic dimensions.

Modifications to embodiments of the present subject matter described in the foregoing are possible without departing from the scope of the present subject matter as defined by the accompanying claims. Expressions such as “including”, “comprising”, “incorporating”, “have”, “is” used to describe and claim the present subject matter are intended to be construed in a non-exclusive manner, namely allowing for items, components or elements not explicitly described also to be present. Reference to the singular is also to be construed to relate to the plural.

What is claimed is:

1. A radio-frequency identification (RFID) tag, comprising:
an antenna;
a strap electrically connected to the antenna; and
a pattern printed layer,
wherein the pattern printed layer comprises a discontinuous adhesive pattern comprising adhesive areas and non-adhesive areas to control dewetting behavior and adhesive release characteristics.

2. The RFID tag of claim 1, wherein the adhesive areas are separated by the non-adhesive areas.

3. The RFID tag of claim 1, further comprising a liner, wherein the pattern printed layer is positioned between the liner and at least one of the antenna, or the strap.

4. The RFID tag of claim 1, wherein the pattern printed layer comprises:
a first pattern in an antenna area and a surrounding area of the antenna, and
a second pattern in a bond pad area where the strap connects to the antenna,
wherein the first pattern and the second pattern have different characteristic dimensions.

5. The RFID tag of claim 4, wherein the first pattern comprises geometric shapes having a first cell size and the second pattern comprises geometric shapes having a second cell size different from the first cell size.

6. The RFID tag of claim 5, wherein the first pattern is configured to provide a first adhesive strength and the second pattern is configured to provide a second adhesive strength, wherein the second adhesive strength is less than the first adhesive strength.

7. The RFID tag of claim 5, wherein the discontinuous adhesive pattern is formed in geometric shapes including hexagonal or honeycomb, triangular, polygonal, and circular shapes.

8. The RFID tag of claim 5, wherein the second pattern is configured to prevent delamination of the strap from the antenna when the RFID tag is removed from a liner.

9. The RFID tag of claim 5, wherein the discontinuous adhesive pattern controls dewetting behavior by creating controlled adhesive flow paths through the non-adhesive areas.

10. A method for manufacturing an RFID tag, comprising:
applying a pattern printed layer on a liner, wherein the pattern printed layer comprises a discontinuous adhesive pattern comprising adhesive areas and non-adhesive areas to control dewetting behavior and adhesive release characteristics;
forming an antenna on the liner over the pattern printed layer; and
electrically connecting a strap to the antenna.

11. The method of claim 10, wherein applying the pattern printed layer comprises:
applying a first pattern in an antenna area and a surrounding area of the antenna; and
applying a second pattern in a bond pad area where the strap connects to the antenna,
wherein the first pattern and the second pattern have different characteristic dimensions.

12. The method of claim 10, wherein the first pattern comprises geometric shapes having a first cell size and the second pattern comprises geometric shapes having a second cell size different from the first cell size.

13. The method of claim 12, wherein the first pattern comprises geometric shapes having a first cell size smaller than a second cell size of the second pattern.

14. The method of claim 12, wherein applying the pattern printed layer comprises applying the first pattern to provide a first adhesive strength and applying the second pattern to provide a second adhesive strength, wherein the second adhesive strength is less than the first adhesive strength.

15. The method of claim 10, wherein applying the discontinuous adhesive pattern comprises forming geometric shapes including hexagonal, honeycomb, triangular, polygonal, or circular shapes.

16. The method of claim 10, wherein the non-adhesive areas prevent adhesive transfer to a facestock layer, thereby providing minimal adhesive residue upon separation of the RFID tag from the liner.

17. A method for controlling dewetting behavior and controlled release in a radio-frequency identification (RFID) tag, comprising:
a pattern printed layer on a substrate, wherein the pattern printed layer comprises a discontinuous adhesive pattern comprising adhesive regions and non-adhesive regions;
controlling dewetting behavior by configuring the non-adhesive regions to create controlled adhesive flow paths; and
controlling release characteristics by positioning the adhesive regions and non-adhesive regions to provide predetermined separation points.

18. The method of claim 17, wherein controlling dewetting behavior comprises preventing adhesive spreading by directing adhesive flow through the controlled adhesive flow paths.

19. The method of claim 17, wherein controlling release characteristics comprises configuring the predetermined separation points to enable release at predetermined force levels.

20. The method of claim 17, further comprising positioning an antenna over the discontinuous adhesive pattern and electrically connecting a strap to the antenna.

21. A radio-frequency identification (RFID) tag with controlled dewetting behavior and controlled release, comprising:
a substrate;
a pattern printed layer applied on the substrate, wherein the pattern printed layer comprises a discontinuous adhesive pattern comprising adhesive regions and non-adhesive regions;
wherein the non-adhesive regions are configured to create controlled adhesive flow paths to control dewetting behavior; and
wherein the adhesive regions and non-adhesive regions are positioned to provide predetermined separation points for controlling release characteristics.

22. The RFID tag of claim 21, further comprising an antenna positioned over the pattern printed layer and a strap electrically connected to the antenna.

23. The RFID tag of claim 21, wherein the predetermined separation points enable release at predetermined force levels.

24. The RFID tag of claim 21, wherein the non-adhesive regions are configured to reduce adhesive residue upon separation from the substrate.

25. The RFID tag of claim 21, wherein the discontinuous adhesive pattern comprises geometric shapes having characteristic dimensions selected to control both dewetting behavior and release force.

26. The RFID tag of claim 21, wherein the pattern printed layer comprises:
a first pattern in an antenna area and a surrounding area of the antenna having first characteristic dimensions; and
a second pattern in a bond pad area having second characteristic dimensions different from the first characteristic dimensions.

27. The RFID tag of claim 26, wherein the first pattern provides first release characteristics and the second pattern provides second release characteristics different from the first release characteristics.

28. The RFID tag of claim 21, wherein the non-adhesive regions create air pockets that facilitate controlled release and improve die cutting yield.

29. The RFID tag of claim 21, wherein the discontinuous adhesive pattern facilitates waste removal during die cutting operations.

30. The RFID tag of claim 21, wherein the pattern printed layer is a pattern printed adhesive layer.
